(19) United States
(12) Patent Application Publication
(10) Pub. No.: US 2026/0212111 A1
(43) Pub. Date: Jul. 23, 2026

(54) INFORMATION PROCESSING APPARATUS, INFORMATION PROCESSING METHOD, AND NON-TRANSITORY RECORDING MEDIUM

(71) Applicants: Wakako TSUCHIYAMA, Tokyo (JP); Mayumi MATSUBARA, Tokyo (JP); Masaki NOSE, Kanagawa (JP)

(72) Inventors: Wakako TSUCHIYAMA, Tokyo (JP); Mayumi MATSUBARA, Tokyo (JP); Masaki NOSE, Kanagawa (JP)

(21) Appl. No.: 19/440,661

(22) Filed: Jan. 6, 2026

(30) Foreign Application Priority Data
Jan. 17, 2025 (JP) 2025-006736

(51) Int. Cl. G06F 40/166; G06F 40/103; G06Q 30/0601; G10L 15/26

(52) U.S. Cl. CPC G06F 40/166; G06F 40/103; G06Q 30/0631; G10L 15/26

(57) ABSTRACT

An information processing apparatus includes circuitry that acquires format information of a document, acquires a speech recognition result of a dialog performed by a plurality of users, generates text data to be included in the document based on the speech recognition result, and generates document data indicating the document based on the text data and the format information.

### CROSS-REFERENCE TO RELATED APPLICATIONS

This patent application is based on and claims priority pursuant to 35 U.S.C. § 119(a) to Japanese Patent Application No. 2025-006736, filed on Jan. 17, 2025, in the Japan Patent Office, the entire disclosure of which is hereby incorporated by reference herein.

### BACKGROUND

### Technical Field

The present disclosure relates to an information processing apparatus, an information processing method, and a non-transitory recording medium.

### Related Art

A technique related to generating a material for proposing a product to a customer has been proposed. For example, a proposal material generation system has been proposed that generates a proposal material based on design information acquired from a website of a proposal destination customer in order to propose a product to the proposal destination customer.

### SUMMARY

The present disclosure described herein provides an information processing apparatus that includes circuitry that acquires format information of a document, acquires a speech recognition result of a dialog performed by a plurality of users, generates text data to be included in the document based on the speech recognition result, and generates document data indicating the document based on the text data and the format information.

The present disclosure described herein provides an information processing method that includes acquiring format information of a document, acquiring a speech recognition result of a dialog performed by a plurality of users, generating text data to be included in the document based on the speech recognition result, and generating document data indicating the document based on the text data and the format information.

The present disclosure described herein provides a non-transitory recording medium storing a plurality of instructions which, when executed by one or more processors, causes the one or more processors to perform an information processing method. The information processing method includes acquiring format information of a document, acquiring a speech recognition result of a dialog performed by a plurality of users, generating text data to be included in the document based on the speech recognition result, and generating document data indicating the document based on the text data and the format information.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a system configuration of a dialog system;

FIG. 2 is a diagram illustrating a hardware configuration of a computer;

FIG. 3 is a diagram illustrating a hardware configuration of a terminal apparatus;

FIG. 4 is a block diagram illustrating a functional configuration of a dialog system;

FIG. 5 is a sequence diagram illustrating a dialog method;

FIG. 6 is a diagram illustrating template information;

FIG. 7 is a flowchart of a text generation process;

FIG. 8 is a diagram illustrating product information;

FIG. 9 is a diagram illustrating text data;

FIG. 10 is a diagram illustrating a dialog screen; and

FIG. 11 is a diagram illustrating a proposal material.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A description is given below of embodiments of the present disclosure with reference to the drawings. In the drawings, an identical or similar reference numeral designates a component having identical or similar function, and redundant descriptions are omitted in the following description.

### Embodiment

The present disclosure relates to an information processing system that provides a dialog service. In the following description, the information processing system is referred to as a “dialog system”. The dialog service is an example of an information communication service that enables dialog with a dialog agent.

In the dialog service, the dialog agent automatically responds to messages from a user, thereby progressing a dialog between the user and the dialog agent. The user of the dialog service may be a single user or a plurality of users. In other words, the dialog service may conduct a one-to-one dialog between the user and the dialog agent, and may also conduct a multi-party dialog including a plurality of users and the dialog agent.

### System Configuration

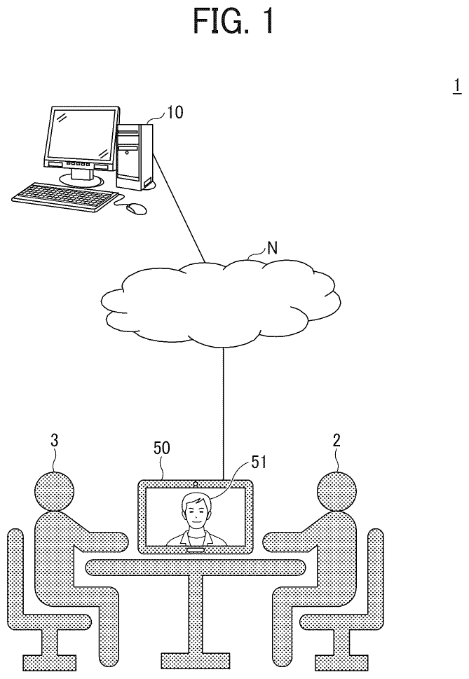

FIG. 1 is a diagram illustrating a system configuration of a dialog system 1. In FIG. 1, the dialog system 1 includes a server apparatus 10 connected to a communication network N such as the Internet or a local area network (LAN), and a terminal apparatus 50.

FIG. 1 illustrates, as one example of a usage scenario of the dialog system 1, a situation in which a sales representative 2 is conducting a business negotiation with a customer 3. The sales representative 2 carries the terminal apparatus 50 that displays a virtual sales agent 51. The sales representative 2 conducts the business negotiation with the customer 3 while involving the virtual sales agent 51. The business negotiation is one example of a dialog. The sales representative 2 and the customer 3 are examples of users of the dialog service. The virtual sales agent 51 is an example of the dialog agent.

The terminal apparatus 50 is an information terminal used by the sales representative 2, such as a personal computer (PC), a tablet PC, or a smartphone. The terminal apparatus 50 acquires a speech utterance of a participant in the business negotiation, such as the speech utterance of the sales representative 2 or the customer 3, and transmits to the server apparatus 10 speech data representing the acquired speech utterance. The speech utterance is an example of an utterance in the dialog. The utterance in the dialog may include, e.g., an utterance in the form of text data such as chat messages. In the following description, the utterance is assumed to be a speech utterance.

The server apparatus 10, which may be referred to as an information processing apparatus, is, for example, a computer or a system including a plurality of computers. The server apparatus 10 acquires the speech data transmitted from the terminal apparatus 50 to generate response content corresponding to the speech utterance indicated by the speech data. The response content includes, e.g., language information, non-language information, recommendation information, and description of the recommendation information of the virtual sales agent 51.

The server apparatus 10 controls the virtual sales agent 51 displayed on the terminal apparatus 50 in accordance with the response content. For example, the server apparatus 10 controls the speech of the virtual sales agent 51 based on the language information of the virtual sales agent 51. In addition, the server apparatus 10 controls, e.g., the display of the virtual sales agent 51 and the output of paralinguistic information based on the non-language information of the virtual sales agent 51. The non-language information includes, e.g., one or more pieces of information on the virtual sales agent 51, which are selected from among an expression, a gaze, a posture, an emotion, a gesture, and the paralinguistic information. The paralinguistic information includes non-verbal audio information such as tone of speech, speech rate, pitch of speech, volume of speech, throat clearing, sigh, laughter, or silence.

The server apparatus 10 implements a generative artificial intelligence (AI). The generative AI such as ChatGPT®, generates text data in response to an input prompt, and outputs the generated text data to the server apparatus 10. The prompt is text data representing, e.g., dialog content, instructions, and questions, to be input to the generative AI that operates on the server apparatus 10. The generative AI does not need to operate on the server apparatus 10, and may be implemented as a device separate from the server apparatus 10. The server apparatus 10 may be implemented by one information processing apparatus or by a plurality of information processing apparatuses.

The terminal apparatus 50 displays the virtual sales agent 51 controlled by the server apparatus 10, and outputs the speech and the paralinguistic information of the virtual sales agent 51. Accordingly, the virtual sales agent 51 may propose recommendation information tailored to the needs of the customer 3, to, e.g., the customer 3 and the sales representative 2, in accordance with a flow of a business negotiation.

As a specific example, when it is determined that the need of the customer 3 is “digitization of invoices,” the virtual sales agent 51 proposes a product related to an electronic invoice issuing system, such as by stating, e.g., “If you are considering digitizing invoices, how about Product A?”. Further, as an explanation of the product, the virtual sales agent 51 may indicate the basis for the proposal, e.g., by stating “Product A has been the best selling product among manufacturing companies in the prefecture this year,” or may perform comparisons with the other products.

The server apparatus 10 may generate the response content that is different for each speaker, in accordance with the acquired speech utterance of the speaker. For example, when the speaker is the sales representative 2, the virtual sales agent 51 displays, on the terminal apparatus 50, materials relating to the product to be proposed to the customer 3, and waits for instructions from the sales representative 2. Accordingly, the sales representative 2 may explain the product based on the materials displayed by the virtual sales agent 51, or may cause the virtual sales agent 51 to explain the product. On the other hand, when the speaker is the customer 3, the virtual sales agent 51 may signal that there is a product available for proposal, e.g., with a gesture such as raising a hand of the virtual sales agent 51. Accordingly, the sales representative 2 instructs the virtual sales agent 51 to propose the product when such a proposal is needed, or cancel the product proposal by the virtual sales agent 51 when such a proposal is not needed.

The term “dialog” refers to a means of transmitting, e.g., information, opinions, and emotions between individuals or groups. Examples of the information being exchanged in the dialog may include verbal information using words, and non-verbal information such as gestures, facial expressions, or body language. The dialog system 1 may carry out other examples of dialogs, e.g., meetings, interviews, lectures, lessons, medical care, nursing care, or counseling.

### Hardware Configuration

### Hardware Configuration of Computer

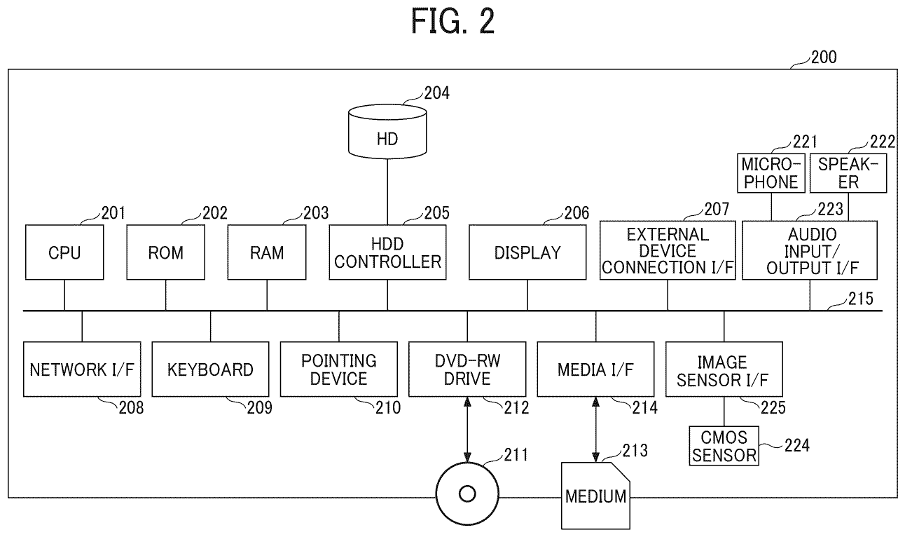

The server apparatus 10 is implemented by a computer 200 having a hardware configuration as illustrated in FIG. 2. Alternatively, the server apparatus 10 may include a plurality of computers 200. The terminal apparatus 50 may also be implemented by the computer 200 having a hardware configuration as illustrated in FIG. 2.

FIG. 2 is a diagram illustrating a hardware configuration of the computer. As illustrated in FIG. 2, the computer 200 includes, e.g., a central processing unit (CPU) 201, a read-only memory (ROM) 202, a random-access memory (RAM) 203, a hard disk (HD) 204, a HD drive (HDD) controller 205, a display 206, an external device connection interface (I/F) 207, a network I/F 208, a keyboard 209, a pointing device 210, a digital versatile disc-rewritable (DVD-RW) drive 212, a media I/F 214, and a bus line 215.

Additionally, when the computer 200 serves as the terminal apparatus 50, the computer 200 further includes, e.g., a microphone 221, a speaker 222, an audio input/output I/F 223, a complementary metal oxide semiconductor (CMOS) sensor 224, and an image sensor I/F 225.

Among these components, the CPU 201 controls the overall operation of the computer 200. The ROM 202 stores, e.g., programs used for booting the computer 200, such as an initial program loader (IPL). The RAM 203 is used as, e.g., a work area for the CPU 201. The HD 204 stores, e.g., programs such as an operating system (OS), applications, device drivers, and various kinds of data. The HDD controller 205 controls, e.g., the reading of data from, or the writing of data to, the HD 204 under control of the CPU 201. The HD 204, the ROM 202, and the RAM 203 are examples of storage devices.

The display 206 displays various examples of information, such as a cursor, a menu, a window, text, or an image. The display 206 may be provided externally of the computer 200. The external device connection I/F 207 is an interface for connecting various external devices to the computer 200. The network I/F 208 is an interface for connecting the computer 200 to the communication network N and for communicating with other devices.

The keyboard 209 is an example of input means including a plurality of keys for inputting characters, numerals, and various instructions. The pointing device 210 is an example of input means for selecting and executing various instructions, selecting processing targets, and moving a cursor. The keyboard 209 and the pointing device 210 may be provided externally of the computer 200.

The DVD-RW drive 212 controls the reading and writing of various data from and to a DVD-RW 211, which is an example of a removable recording medium. The DVD-RW 211 is not limited to a DVD-RW, and may be any other removable recording medium. The media I/F 214 controls the reading and writing (storage) of data from and to a medium 213 such as a flash memory. The bus line 215 includes an address bus, a data bus, and various control signals for electrically connecting the above-mentioned components.

The microphone 221 is a built-in circuit that converts sound into an electrical signal. The speaker 222 is a built-in circuit that converts an electrical signal into physical vibrations to produce sounds such as music or speech. The audio input/output I/F 223 is a circuit that processes the input and output of audio signals between the microphone 221 and the speaker 222 under the control of the CPU 201.

The CMOS sensor 224 is an example of built-in image capturing means that, under the control of the CPU 201, captures a subject (for example, a self-image) to obtain image data. The computer 200 may have, instead of the CMOS sensor 224, an image capturing means such as a charge-coupled device (CCD) sensor. The image sensor I/F 225 is a circuit that controls the driving of the CMOS sensor 224.

### Hardware Configuration of Terminal Apparatus

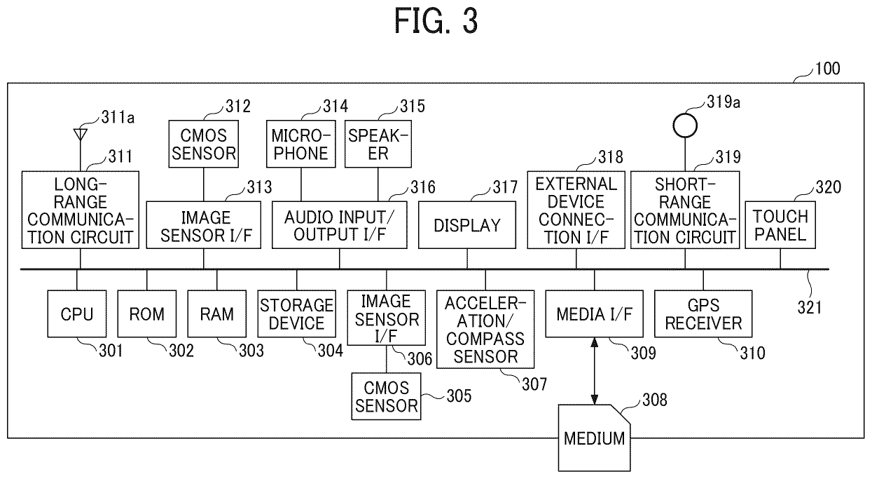

FIG. 3 is a diagram illustrating a hardware configuration of the terminal apparatus 10. An example of a hardware configuration of the terminal apparatus 50 in a case where the terminal apparatus 50 is an information terminal such as a smartphone or a tablet terminal will be described.

In the example of FIG. 3, the terminal apparatus 50 includes a CPU 301, a ROM 302, a RAM 303, a storage device 304, a CMOS sensor 305, an image sensor I/F 306, an acceleration/compass sensor 307, a media I/F 309, and a global positioning system (GPS) receiver 310.

Among these components, the CPU 301 controls the overall operation of the terminal apparatus 50 by executing predetermined programs. The ROM 302 stores, e.g., programs used for booting the CPU 301, such as an IPL. The RAM 303 is used as a work area for the CPU 301. The storage device 304 is a large-capacity storage device that stores programs such as an OS and applications, as well as various kinds of data, and is implemented, for example, by a solid-state drive (SSD) or a flash ROM.

The CMOS sensor 305 is an example of built-in image capturing means that, under the control of the CPU 301, captures a subject (mainly a self-image) to obtain image data. The terminal apparatus 50 may have, instead of the CMOS sensor 305, an image capturing means such as a CCD sensor. The image sensor I/F 306 is a circuit that controls the driving of the CMOS sensor 305. The acceleration/compass sensor 307 is a sensor such as an electronic magnetic compass or a gyro compass for detecting geomagnetism, or an acceleration sensor. The media I/F 309 controls the reading and writing (storage) of data from and to a medium (storage medium) 308 such as a flash memory. The GPS receiver 310 receives GPS signals (positioning signals) from GPS satellites.

The terminal apparatus 50 includes a long-range communication circuit 311, an antenna 311a of the long-range communication circuit 311, a CMOS sensor 312, an image sensor I/F 313, a microphone 314, a speaker 315, an audio input/output I/F 316, a display 317, an external device connection I/F 318, a short-range communication circuit 319, an antenna 319a of the short-range communication circuit 319, and a touch panel 320.

The long-range communication circuit 311 is a circuit that communicates with another device via the communication network N. The CMOS sensor 312 is an example of built-in imaging means that captures a subject under the control of the CPU 301 to acquire image data. The image sensor I/F 313 is a circuit that controls the driving of the CMOS sensor 312. The microphone 314 is a built-in circuit that converts sound into an electrical signal. The speaker 315 is a built-in circuit that converts the electrical signal into physical vibrations to produce sounds such as music or speech. The audio input/output I/F 316 is a circuit that processes the input and output of audio signals with the microphone 314 and the speaker 315 under the control of the CPU 301.

The display 317 is an example of display means such as a liquid crystal display or an organic electro luminescence (EL) display, that displays an image of a subject, and various icons. The external device connection I/F 318 is an interface for connecting various external devices. The short-range communication circuit 319 includes a circuit that performs short-range wireless communication. The touch panel 320 is an example of input means that enables the user to operate the terminal apparatus 50 by pressing the display 317.

The terminal apparatus 50 further includes a bus line 321. The bus line 321 includes an address bus, a data bus, and various control signals for electrically connecting the respective components such as the CPU 301 illustrated in FIG. 3.

The hardware configuration of the terminal apparatus 50 illustrated in FIG. 3 is merely an example. The terminal apparatus 50 may have any other hardware configuration that includes components such as a computer configuration, a communication circuit, a display, a microphone, and a speaker.

### Functional Configuration

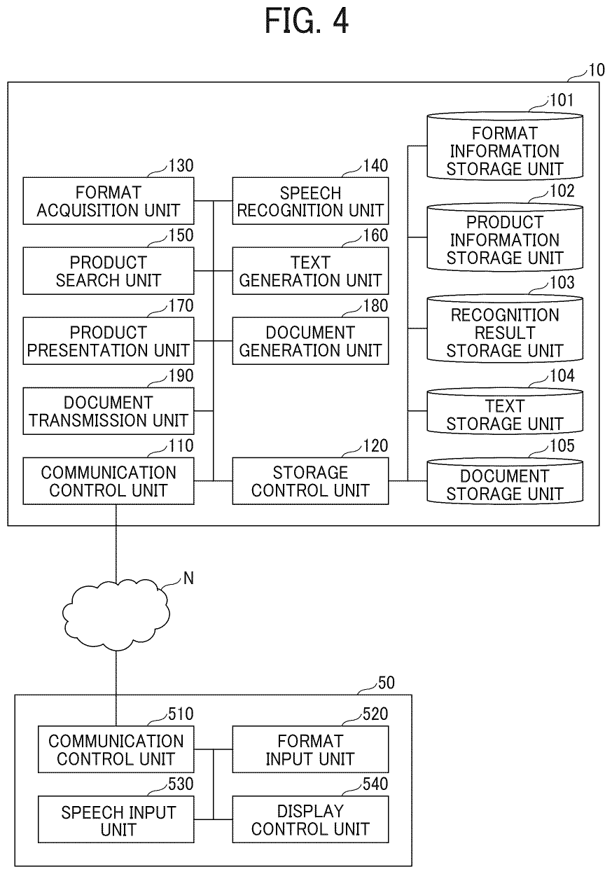

A description is given below of a block diagram illustrating a functional configuration of the dialog system 1, with reference to FIG. 4. FIG. 4 is a block diagram illustrating a functional configuration of the dialog system 1.

### Server Apparatus

As illustrated in FIG. 4, the server apparatus 10 includes a format information storage unit 101, a product information storage unit 102, a recognition result storage unit 103, a text storage unit 104, a document storage unit 105, a communication control unit 110, a storage control unit 120, a format acquisition unit 130, a speech recognition unit 140, a product search unit 150, a text generation unit 160, a product presentation unit 170, a document generation unit 180, and a document transmission unit 190.

The format information storage unit 101, the product information storage unit 102, the recognition result storage unit 103, the text storage unit 104, and the document storage unit 105 are implemented, e.g., by the HD 204 illustrated in FIG. 2. Reading or writing of data stored in the HD 204 is performed, e.g., via the HDD controller 205.

The communication control unit 110, the storage control unit 120, the format acquisition unit 130, the speech recognition unit 140, the product search unit 150, the text generation unit 160, the product presentation unit 170, the document generation unit 180, and the document transmission unit 190 are implemented by the CPU 201 that operates in cooperation with the network I/F 208 according to a program deployed from the ROM 202 onto the RAM 203, as illustrated in FIG. 2.

The format information storage unit 101 stores format information. The format information storage unit 101 may store the format information in advance. The format information storage unit 101 may store the format information received from the terminal apparatus 50.

The format information is an example of electronic data indicating a document format. The format information may be, e.g., template information of a document. The document may include, e.g., a proposal, minutes, a report, or a contract. The template information may include, e.g., a page layout of the document, headings of the document, items to be described on each page, and arrangement of items included in each page. The template information may include placeholders for embedding data. The placeholders may allow embedding of any desired data such as text data, image data, or speech data.

The product information storage unit 102 stores product information. The product information storage unit 102 may store the product information in advance. The product information storage unit 102 may store the product information received from the terminal apparatus 50.

The product information is an example of electronic data indicating information relating to a product. A product is an example of an object that may be referred to in a business negotiation. The product may include, e.g., goods or services handled by the sales representative 2. The product information may include key information used for searching. The key information may include, for example, keywords related to the product, and may include a document vector extracted from the product information.

The recognition result storage unit 103 stores a speech recognition result of a dialog. The speech recognition result stored in the recognition result storage unit 103 may be generated by the speech recognition unit 140.

The speech recognition result is an example of text data acquired by recognizing speech data received from the terminal apparatus 50. The speech recognition result of a dialog may be data in which a plurality of text data acquired by recognizing speech data received during the dialog are stored in the chronological order.

The recognition result storage unit 103 may store a speech recognition result for each dialog. The recognition result storage unit 103 may store a speech recognition result for each customer 3. The recognition result storage unit 103 may store speech recognition results obtained in a plurality of business negotiations with the same customer 3 in association with one another.

The text storage unit 104 stores text data to be included in a document. The text data stored in the text storage unit 104 may be generated by the text generation unit 160.

The text storage unit 104 may store text data for each dialog. The text storage unit 104 may store text data for each customer 3. The text storage unit 104 may store text data for each product.

The document storage unit 105 stores document data. The document data stored in the document storage unit 105 may be generated by the document generation unit 180. The document data stored in the document storage unit 105 may be edited by the document generation unit 180.

The document data is an example of electronic data representing a document. The document data may be stored in any file format. The file format may include, e.g., a presentation format, a word processing format, a text format, or a spreadsheet format.

The communication control unit 110 controls communication with the terminal apparatus 50. The communication control unit 110 may receive format information input to the terminal apparatus 50 from the terminal apparatus 50. The communication control unit 110 may receive speech data indicating speech utterance input into the terminal apparatus 50 from the terminal apparatus 50. The communication control unit 110 may transmit response content corresponding to the speech utterance to the terminal apparatus 50. The communication control unit 110 may transmit screen data for displaying a dialog screen on the terminal apparatus 50 to the terminal apparatus 50.

The screen data is electronic data for causing a screen to be displayed on the display 317 of the terminal apparatus 50. The screen data is electronic data described in, e.g., hypertext markup language (HTML), and may include a program described in a script language such as JavaScript®.

The storage control unit 120 controls storage of data in a storage device of the server apparatus 10. The storage control unit 120 may read and write format information from and to the format information storage unit 101. The storage control unit 120 may read product information from the product information storage unit 102. The storage control unit 120 may read and write speech recognition results from and to the recognition result storage unit 103. The storage control unit 120 may read and write text data from and to the text storage unit 104. The storage control unit 120 may read and write document data from and to the document storage unit 105.

The format acquisition unit 130 acquires format information. The format acquisition unit 130 may acquire format information received from the terminal apparatus 50. The format acquisition unit 130 may perform control to store the format information in the format information storage unit 101.

The speech recognition unit 140 recognizes a user's speech utterance. The speech recognition unit 140 may recognize a user's speech utterance based on speech data received from the terminal apparatus 50. The speech recognition unit 140 may recognize each speech utterance of a plurality of users participating in a dialog. The speech recognition unit 140 may generate a speech recognition result of the dialog by storing, in the chronological order, respective speech recognition results of the speech utterances.

The speech recognition unit 140 may store a speech recognition result of the dialog in the recognition result storage unit 103. The speech recognition unit 140 may accumulate, in the recognition result storage unit 103, speech recognition results generated during the dialog in the chronological order to generate the speech recognition result of the dialog.

The product search unit 150 searches product information. The product search unit 150 may search the product information based on the speech recognition result generated by the speech recognition unit 140. The product search unit 150 may search the product information stored in the product information storage unit 102.

The product search unit 150 may extract a keyword from a speech recognition result of a dialog. The product search unit 150 may extract a keyword based on a language model. The keyword may include a word or a sentence indicating a topic of the dialog. The topic of the dialog may include a need of the customer 3. The need of the customer 3 may include, e.g., a request, a problem, a concern, or a difficulty. The product search unit 150 may extract product information matching the keyword from the product information stored in the product information storage unit 102.

The product search unit 150 may generate a search query based on a speech recognition result of a dialog.

The product search unit 150 may generate a search query based on a language model. The product search unit 150 may generate a search query indicating a need of the customer 3. The product search unit 150 may extract, from the product information stored in the product information storage unit 102, product information whose distance between the search query and a document vector is less than a threshold. In other words, the product search unit 150 may extract, from the product information stored in the product information storage unit 102, product information that is similar to the search query.

A language model is an example of a machine learning model trained to perform predetermined language processing. The language model may be a large language model (LLM) trained to perform various language processing tasks, or a small language model (SLM) trained to perform specific language processing tasks. The language model may be incorporated in the server apparatus 10, or may be stored in another information processing apparatus that is communicable via the communication network N.

The text generation unit 160 generates text data to be included in a document. The text generation unit 160 may generate the text data based on a language model. The text generation unit 160 may generate the text data based on a speech recognition result of a dialog. The text generation unit 160 may generate the text data based on product information retrieved by the product search unit 150.

The text generation unit 160 may generate text data for each product. The text generation unit 160 may omit generation of text data for a product for which text data has already been generated. The text generation unit 160 may store the text data in the text storage unit 104.

The product presentation unit 170 presents product information to a user. The product presentation unit 170 may present product information for a product for which text data has been generated by the text generation unit 160. The product presentation unit 170 may present product information relating to a product mentioned during a dialog. For example, the product presentation unit 170 may present product information relating to a product explained by the sales representative 2 to the customer 3 during a sales negotiation, to the sales representative 2 or the customer 3.

The product presentation unit 170 may generate screen data including product information to be presented to a user.

The product presentation unit 170 may transmit the screen data including the product information to the terminal apparatus 50. The terminal apparatus 50 may output the dialog screen displaying the product information on the display 317, based on the screen data including the product information.

The document generation unit 180 generates document data. The document generation unit 180 may generate the document data based on format information read from the format information storage unit 101. The document generation unit 180 may generate the document data based on text data read from the text storage unit 104. The document generation unit 180 may generate the document data based on product information read from the product information storage unit 102.

For example, the document generation unit 180 may describe the text data in accordance with the format indicated by the format information. The document generation unit 180 may embed the text data into a placeholder of the template information. The document generation unit 180 may embed the product information into a placeholder of the template information.

The document generation unit 180 may generate document data relating to a product designated by a user.

The designation of the product by the user may be performed on a screen on which the product presentation unit 170 presents product information to the user.

The document generation unit 180 may edit the document data. The document generation unit 180 may edit the document data based on instructions from the user. The document generation unit 180 may delete a portion of the document data. The document generation unit 180 may modify text data included in the document data. For example, the document generation unit 180 may delete one or more pages included in the document data. For example, the document generation unit 180 may revise text data embedded in a placeholder.

The document generation unit 180 may store the generated document data in the document storage unit 105. The document generation unit 180 may store the edited document data in the document storage unit 105.

The document transmission unit 190 transmits the document data. The document transmission unit 190 may transmit the document data to the terminal apparatus 50. The document transmission unit 190 may control transmission of screen data including the document data to the terminal apparatus 50. The terminal apparatus 50 may output to the display 317 a screen for displaying the document data, based on the screen data.

The document transmission unit 190 may transmit the document data to one or more users. For example, the document transmission unit 190 may transmit the document data to a user via a communication service such as electronic mail, a messaging service, or a social networking service (SNS).

The document transmission unit 190 may transmit the document data to a sales representative 2. The sales representative 2 may forward the document data received from the server apparatus 10 to a customer 3. The document transmission unit 190 may transmit the document data to the customer 3. The document transmission unit 190 may acquire customer information including contact details of the customer 3 (for example, an email address) for transmitting the document data to the customer 3.

### Terminal Apparatus

As illustrated in FIG. 4, the terminal apparatus 50 includes a communication control unit 510, a format input unit 520, a speech input unit 530, and a display control unit 540.

The communication control unit 510, the format input unit 520, the speech input unit 530, and the display control unit 540 are implemented, e.g., by the CPU 301 that performs processing according to a program deployed from the ROM 302 onto the RAM 303, as illustrated in FIG. 3.

The communication control unit 510 controls communication with the server apparatus 10. The communication control unit 510 may transmit format information input to the terminal apparatus 50 to the server apparatus 10. The communication control unit 510 may transmit speech data indicating speech utterance input to the terminal apparatus 50 to the server apparatus 10. The communication control unit 510 may receive, from the server apparatus 10, response content to the speech utterance. The communication control unit 510 may receive, from the server apparatus 10, screen data for displaying the dialog screen on the terminal apparatus 50.

The format input unit 520 accepts input of format information. The format input unit 520 may accept format information input by a user into the terminal apparatus 50. The format information may be input on a screen displayed on the display 317. The format input unit 520 may transmit the format information to the server apparatus 10.

The speech input unit 530 accepts input of speech data indicating speech utterance. The speech input unit 530 may detect the user's speech utterance based on an acoustic signal of sounds collected by the microphone 314. The speech input unit 530 may generate speech data including a speech segment detected from the acoustic signal. The speech input unit 530 may transmit the speech data to the server apparatus 10.

The display control unit 540 performs control to display, on the display 317, a screen provided by the dialog system 1. The display control unit 540 may be, e.g., an application having a browser function. The application having the browser function may be a web browser pre-installed in the terminal apparatus 50, or may be an application that displays web content by using a web view function.

The display control unit 540 may display the dialog screen based on screen data received from the server apparatus 10. The display control unit 540 may display the dialog screen including a dialog agent. The display control unit 540 may display the dialog screen including product information. The display control unit 540 may display the dialog screen including document data.

### Processing

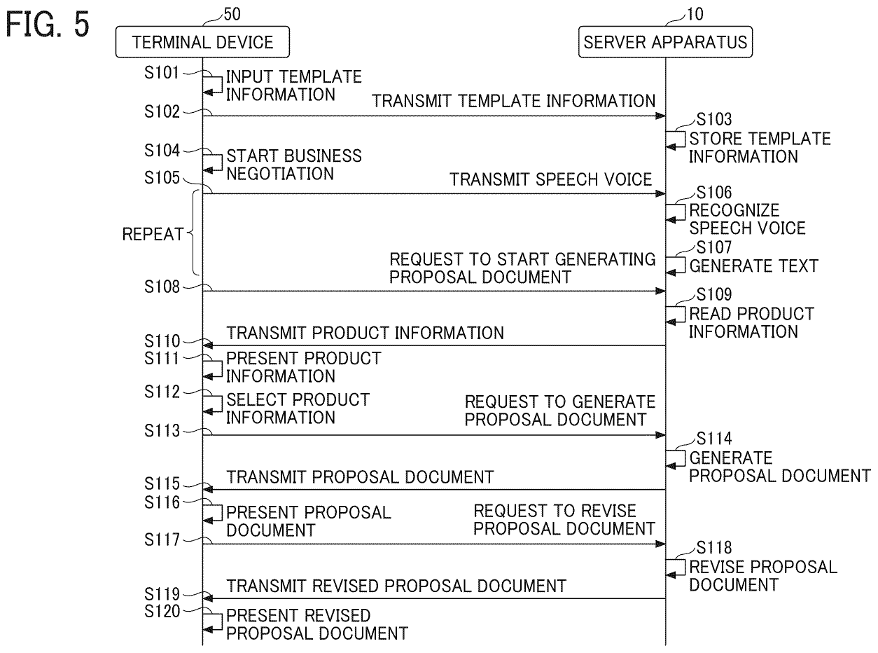

A description is given below of the process of conducting the dialog executed by the dialog system 1 with reference to FIGS. 5 to 11. FIG. 5 is a sequence diagram illustrating an example of the dialog process. In the following description, an example will be described in which, in a business negotiation between a sales representative 2 and a customer 3, proposal materials, which are an example of a document, are generated based on template information, which is an example of format information.

The sales representative 2 inputs template information into the terminal apparatus 50. In step S101, the format input unit 520 of the terminal apparatus 50 receives the user input of the template information. The format input unit 520 transmits the received template information to the communication control unit 510.

In step S102, the communication control unit 510 of the terminal apparatus 50 receives the template information from the format input unit 520. The communication control unit 510 transmits the template information to the server apparatus 10.

In step S103, the communication control unit 110 of the server apparatus 10 receives the template information from the terminal apparatus 50. The communication control unit 110 sends the received template information to the format acquisition unit 130. The format acquisition unit 130 sends the template information received from the communication control unit 110 to the storage control unit 120. The storage control unit 120 stores the template information received from the format acquisition unit 130 in the format information storage unit 101.

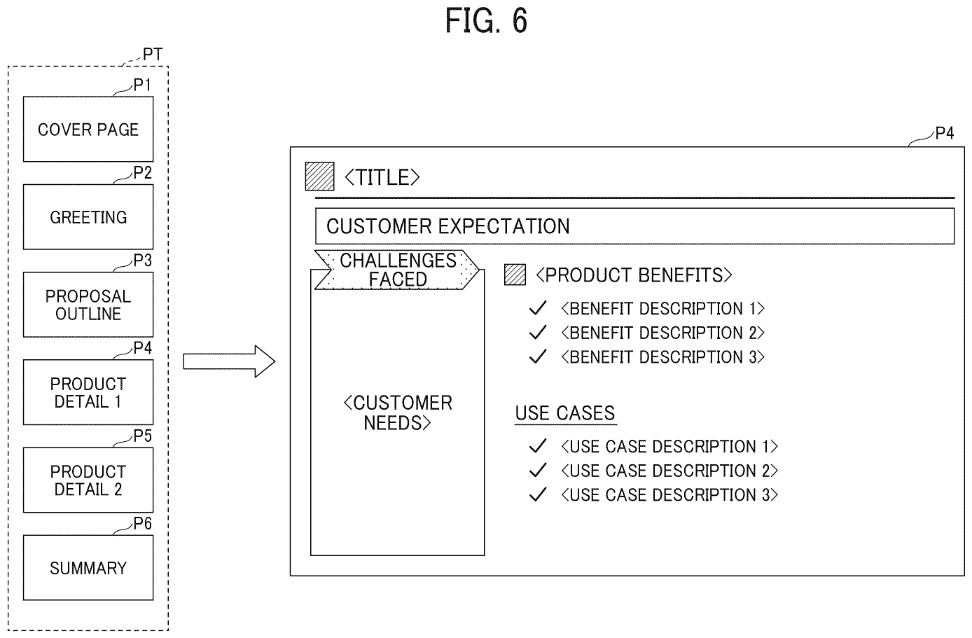

FIG. 6 is a diagram illustrating the template information. In FIG. 6, the template information PT of proposal materials generated in a presentation format is illustrated. As illustrated in FIG. 6, the template information PT may include a plurality of pages P1 to P6. Pages P1 to P5 may each have a heading set therein. The page headings may include, e.g., a cover, a greeting, a proposal outline, product details, and a summary. Each heading may include a plurality of pages. For example, the template information PT illustrated in FIG. 6 includes two pages of product details.

Each of pages P1 to P6 of the template information PT may have a layout of items included in the page predetermined. The items included in the page may include text, shapes, tables, animations, still images, moving images, and speech. The items included in the page may include fixed information and may include placeholders into which data is to be embedded. Identification information for identifying the placeholder may be set in the placeholder.

FIG. 6 illustrates an example of page P4 that describes product details. The page P4 illustrated in FIG. 6 includes a plurality of placeholders in which item names are enclosed by angle brackets (“<” and “>”).

The page P4 includes placeholders into which a title, customer needs, effects of the product, and descriptions of usage scenes are to be embedded.

Returning to FIG. 5, the description continues. The sales representative 2 and the customer 3 start a business negotiation. In step S104, the speech input unit 530 of the terminal apparatus 50 receives input of speech data indicating speech utterance of the sales representative 2 or the customer 3. The speech input unit 530 transmits the received speech data to the communication control unit 510.

In step S105, the communication control unit 510 of the terminal apparatus 50 receives the speech data from the speech input unit 530. The communication control unit 510 transmits the speech data to the server apparatus 10.

In step S106, the communication control unit 110 of the server apparatus 10 receives speech data from the terminal apparatus 50. The communication control unit 110 transmits the received speech data to the speech recognition unit 140. The speech recognition unit 140 recognizes speech uttered by the sales representative 2 or the customer 3, based on the speech data. The speech recognition unit 140 transmits the speech recognition result to the storage control unit 120. The storage control unit 120 stores the speech recognition result in the recognition result storage unit 103.

In step S107, the server apparatus 10 generates text data to be included in a proposal document, based on the speech recognition result generated in step S106. The server apparatus 10 may repeatedly execute step S107 at predetermined time intervals. As one example, the predetermined time interval may be set to approximately 15 seconds.

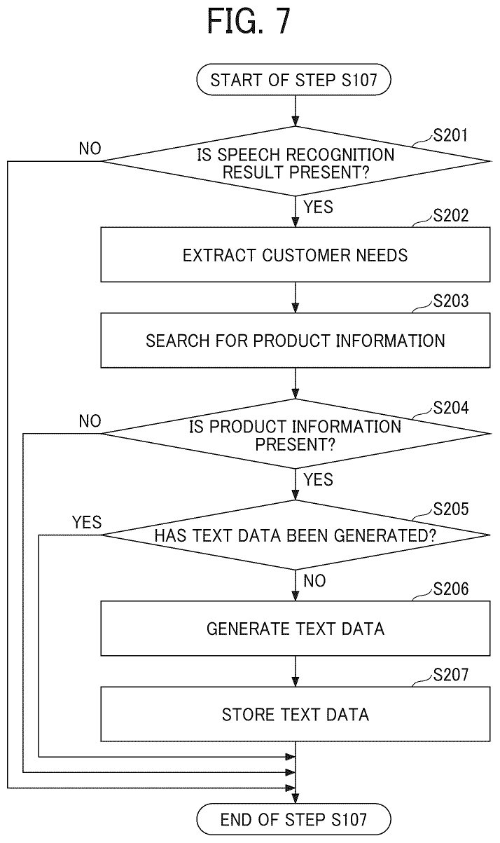

The text generation process (step S107 in FIG. 5) executed by the server apparatus 10 will be described in greater detail with reference to FIGS. 7 to 9. FIG. 7 is a flowchart illustrating one example of the text generation process.

In step S201, the storage control unit 120 of the server apparatus 10 reads out the speech recognition result from the recognition result storage unit 103. The server apparatus 10 determines, based on the read speech recognition result, whether a speech recognition result to be processed is present. The speech recognition result to be processed is a speech recognition result that has been generated after the previous execution of the text generation process.

When the server apparatus 10 determines that a speech recognition result to be processed is present (YES), the server apparatus 10 advances the processing to step S202. On the other hand, when the server apparatus 10 determines that no speech recognition result to be processed is present (NO), the server apparatus 10 ends the text generation process.

In step S202, the product search unit 150 of the server apparatus 10 acquires the speech recognition result to be processed from the storage control unit 120. The product search unit 150 extracts the needs of the customer 3 based on the speech recognition result to be processed. For example, the product search unit 150 may extract keywords indicating the needs of the customer 3 from the speech recognition result to be processed. Alternatively, e.g., the product search unit 150 may generate a search query indicating the needs of the customer 3 based on the speech recognition result to be processed.

In step S203, the product search unit 150 of the server apparatus 10 searches for product information related to the needs of the customer 3 from the product information stored in the product information storage unit 102. For example, the product search unit 150 may extract product information from the product information storage unit 102 in which keywords match. Alternatively, e.g., the product search unit 150 may extract product information from the product information storage unit 102 in which the distance between a search query and a document vector associated with each product is small. Alternatively, e.g., the product search unit 150 may search for and extract products based on a space generated from text information relating to products stored in the product information storage unit 102. The search and extraction may be performed by a method commonly referred to as retrieval-augmented generation (RAG).

The document vector is an embedding vector generated from the product information. The document vector may be generated based on at least one of the product name or a description of the product. The document vector may be generated based on a language model.

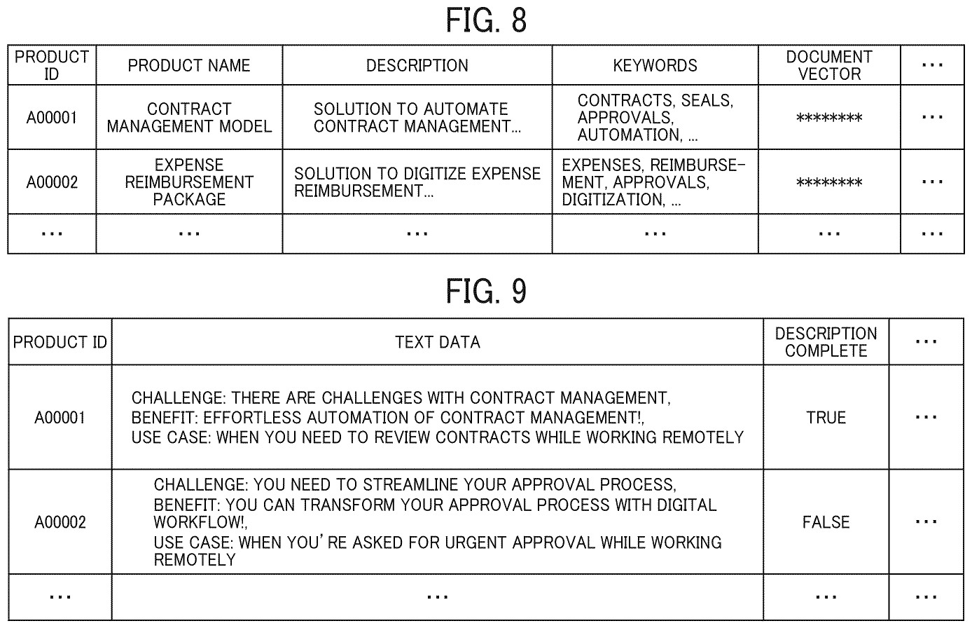

FIG. 8 is a diagram illustrating product information. As illustrated in FIG. 8, the product information may include, as data items, a product ID, a product name, a description of the product, keywords, and document vectors. The product ID is one example of identification information for identifying a product. The product name is the name of the product. The description is one example of a sentence describing the content of the product. The product information may include only one of the keywords or the document vectors.

The keyword is a keyword related to the product. The keyword may include, e.g., a word or a sentence indicating an issue to be solved by the product, an effect obtained by introducing the product, and a usage scene of the product. The keyword may be extracted from the product name or the description of the product.

Returning to FIG. 7, the description will be continued. In step S204, the product search unit 150 of the server apparatus 10 determines whether product information related to the needs of the customer 3 is present. In other words, the product search unit 150 determines whether one or more pieces of product information have been retrieved in step S203.

When it is determined that product information related to the needs of the customer 3 is present (YES), the server apparatus 10 proceeds to step S205. On the other hand, when it is determined that product information related to the needs of the customer 3 is not present (NO), the server apparatus 10 terminates the text generation process.

In step S205, the product search unit 150 of the server apparatus 10 transmits identification information of the product information (e.g., a product ID) extracted in step S204 to the storage control unit 120. The storage control unit 120 reads out the product information from the product information storage unit 102 based on the identification information of the product information. The storage control unit 120 transmits the read product information to the text generation unit 160.

The text generation unit 160 determines whether text data has already been generated for the product information received from the storage control unit 120. Specifically, the text generation unit 160 determines whether text data relating to the product information is stored in the text storage unit 104.

When it is determined that the text data has already been generated (YES), the server apparatus 10 terminates the text generation process. On the other hand, when it is determined that the text data has not been generated (NO), the server apparatus 10 proceeds to step S206.

In step S206, the text generation unit 160 of the server apparatus 10 generates text data to be included in a proposal document, based on the speech recognition result read in step S201 and the product information read in step S205. Specifically, the text generation unit 160 may cause a language model to generate the text data to be included in the proposal document by inputting a prompt including the speech recognition result and the product information into the language model.

The prompt may include instruction information for instructing generation of the text data. As one example, the instruction information may include content such as “In order to introduce a product that can appeal to the customer's concerns, write in polite language the content to be inserted into the document based on the customer's speech”. The prompt may include constraint conditions specifying, e.g., the number of characters of the text data or the ending of sentences.

The text generation unit 160 transmits the generated text data to the storage control unit 120. The storage control unit 120 stores, in the text storage unit 104, the text data received from the text generation unit 160.

FIG. 9 is a diagram illustrating one example of text data. As illustrated in FIG. 9, the text data is data indicating text to be included in a document. The text data may include text data to be embedded in placeholders of template information. The text data may be associated with item names of the placeholders.

FIG. 9 illustrates an example in which a plurality of text data items separated by commas (“,”) are stored in a single data field. However, the plurality of text data items may separately be stored in different data fields. FIG. 9 illustrates an example in which an item name of a placeholder and text data are associated with each other by an equal sign (“=”). However, the item name of the placeholder and the text data may separately be stored in different data fields.

The text data may be associated with a product ID. That is, the text data may be generated for each product. The text data may be associated with a description flag. The description flag is a boolean value indicating whether the product has been described during a business meeting. The description flag may be set to true (described) by the server apparatus 10 when the virtual sales representative 51 has uttered a description of the product. Alternatively, the description flag may be set to true (described) by the sales representative 2 when the sales representative 2 has described the product to the customer 3.

Returning to FIG. 5, the description will be continued. In step S108, the sales representative 2 or the customer 3 performs a proposal document generation start operation. The proposal document generation start operation may be a spoken utterance instructing generation of the proposal document, or may be performed via a screen displayed on the display 317 of the terminal apparatus 50. As one example, the sales representative 2 may utter content such as “Generate a proposal document.” The communication control unit 510 of the terminal apparatus 50 transmits a generation start request to the server apparatus 10 in response to the proposal document generation start operation.

In step S109, the communication control unit 110 of the server apparatus 10 receives a generation start request from the terminal apparatus 50. When the communication control unit 110 receives the generation start request, the storage control unit 120 reads out product information for which text data has already been generated from the product information storage unit 102. Specifically, the storage control unit 120 extracts text data from the text storage unit 104 in which the description flag is set to true (described). The storage control unit 120 then acquires the product ID associated with the extracted text data. Subsequently, the storage control unit 120 reads out the product information including the acquired product ID from the product information storage unit 102.

In step S110, the storage control unit 120 transmits the product information read in step S109 to the product presentation unit 170. The product presentation unit 170 generates screen data including the product information received from the storage control unit 120. The product presentation unit 170 transmits the screen data including the product information to the communication control unit 110. The communication control unit 110 transmits the screen data including the product information to the terminal apparatus 50.

In step S111, the communication control unit 510 of the terminal apparatus 50 receives screen data including product information from the server apparatus 10. When the communication control unit 510 receives the screen data including the product information, the display control unit 540 outputs, to the display 317, the dialog screen that displays the product information based on the screen data including the product information. That is, the terminal apparatus 50 presents, to the user, product information for which a proposal document can be created.

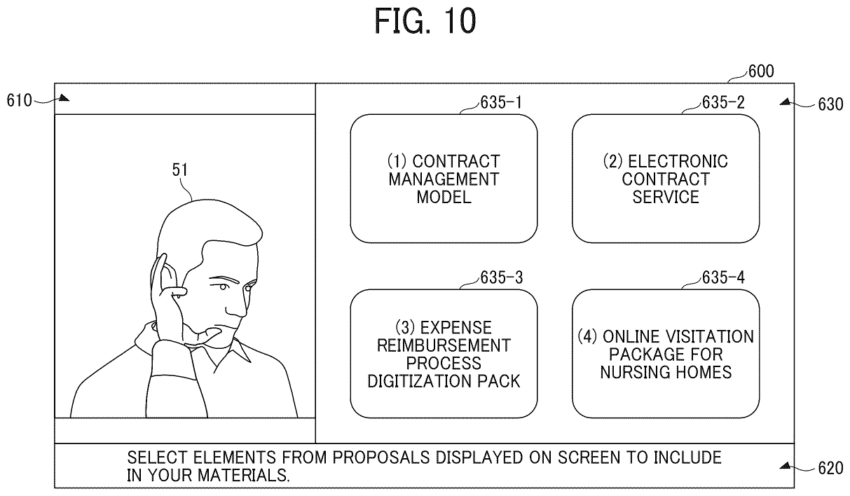

FIG. 10 is a diagram illustrating the dialog screen. As illustrated in FIG. 10, the dialog screen 600 may include an agent display area 610, a message display area 620, and a product presentation area 630.

The agent display area 610 is an area for displaying the virtual sales agent 51. The message display area 620 is an area for displaying messages to be notified to the user. In the example illustrated in FIG. 10, the message display area 620 displays a message requesting selection of a product for which a proposal document is to be created.

The product presentation area 630 includes one or more product display areas 635 (635-1 to 635-4). The product display area 635 is an area for displaying product information for which a proposal document can be generated.

Specifically, the product display area 635 displays product information for which text data is stored in the text storage unit 104. FIG. 10 illustrates the product presentation area 630 including four product display areas 635-1 to 635-4. However, the number of product display areas 635 may be three or less, or five or more.

The product presentation area 630 displays the product display area 635 in a selectable manner. The product presentation area 630 may display a plurality of product display areas 635 in a selectable manner. When a product display area 635 is selected in the product presentation area 630, the product information displayed in the selected product display area 635 is designated as product information to be included in the proposal document.

Returning to FIG. 5, the description will be continued. In step S112, a user of the dialog system 1 may select, in the dialog screen 600 displayed on the terminal apparatus 50, product information for which a proposal document is to be generated. The display control unit 540 of the terminal apparatus 50 may receive designation of the product information.

In step S113, the display control unit 540 of the terminal apparatus 50 transmits identification information of the product information designated by the user in step S112 to the communication control unit 510. The communication control unit 510 transmits a proposal document generation request to the server apparatus 10. The proposal document generation request includes the identification information of the product information designated by the user.

In step S114, the communication control unit 110 of the server apparatus 10 receives a proposal document generation request from the terminal apparatus 50. When the communication control unit 110 receives the proposal document generation request, the storage control unit 120 reads out text data from the text storage unit 104 based on the identification information included in the proposal document generation request. The storage control unit 120 also reads out template information from the format information storage unit 101.

The storage control unit 120 transmits the text data and the template information to the document generation unit 180. The document generation unit 180 generates a proposal document based on the text data and the template information received from the storage control unit 120. Specifically, the document generation unit 180 embeds the text data into placeholders of the template information. The document generation unit 180 transmits the generated proposal document to the storage control unit 120. The storage control unit 120 stores the proposal document received from the document generation unit 180 in the document storage unit 105.

In step S115, the document generation unit 180 of the server apparatus 10 transmits the proposal document generated in step S114 to the document transmission unit 190. The document transmission unit 190 generates screen data including the proposal document. The document transmission unit 190 transmits the screen data including the proposal document to the communication control unit 110. The communication control unit 110 transmits the screen data including the proposal document to the terminal apparatus 50.

In step S116, the communication control unit 510 of the terminal apparatus 50 receives screen data including the proposal document from the server apparatus 10. When the communication control unit 510 receives the screen data including the proposal document, the display control unit 540 outputs, to the display 317, a dialog screen that displays the proposal document based on the screen data including the proposal document. In other words, the terminal apparatus 50 presents to the user the proposal document relating to the product information selected in step S112.

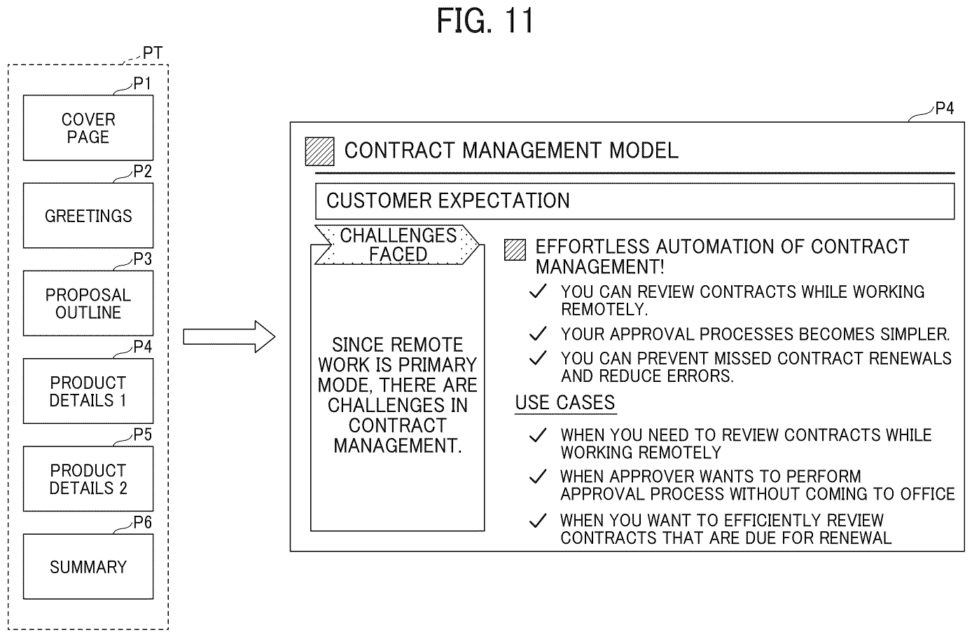

FIG. 11 is a diagram illustrating one example of a proposal document according to one embodiment. FIG. 11 illustrates a proposal document PM in which the text data illustrated in FIG. 9 is embedded into the template information PT illustrated in FIG. 6. As illustrated in FIG. 11, it can be seen that the text data is embedded in each placeholder included in the template information PT of the proposal document PM.

Returning to FIG. 5, the description will be continued. In step S117, the server apparatus 10 receives an operation to modify the proposal document from the sales representative 2 or the customer 3. The proposal document modification operation may be a spoken utterance instructing modification of the proposal document, or may be performed via a screen displayed on the display 317 of the terminal apparatus 50. As one example, the customer 3 may utter content such as “I selected this product. But I don't need it, so delete it”.

The communication control unit 510 of the terminal apparatus 50 transmits a proposal document modification request to the server apparatus 10 in response to the proposal document modification operation. The proposal document modification request includes information indicating the modification content.

In step S118, the communication control unit 110 of the server apparatus 10 receives a proposal document modification request from the terminal apparatus 50. When the communication control unit 110 receives the proposal document modification request, the document generation unit 180 modifies the proposal document generated in step S114 based on the information indicating the modification content included in the proposal document modification request. The document generation unit 180 transmits the modified proposal document to the storage control unit 120. The storage control unit 120 stores the modified proposal document received from the document generation unit 180 in the document storage unit 105.

In step S119, the document generation unit 180 of the server apparatus 10 transmits the proposal document modified in step S118 to the document transmission unit 190. The document transmission unit 190 generates screen data including the modified proposal document. The document transmission unit 190 transmits the screen data including the modified proposal document to the communication control unit 110. The communication control unit 110 transmits the screen data including the modified proposal document to the terminal apparatus 50.

In step S120, the communication control unit 510 of the terminal apparatus 50 receives screen data including the modified proposal document from the server apparatus 10. When the communication control unit 510 receives the screen data including the modified proposal document, the display control unit 540 updates the proposal document displayed in the dialog screen to the modified proposal document based on the screen data including the modified proposal document. In other words, the terminal apparatus 50 presents to the user the proposal document modified in step S118.

The processing from step S117 to step S120 may be executed optionally. For example, the processing from step S117 to step S120 may not be executed. In addition, the processing from step S117 to step S120 may be executed a plurality of times.

In step S115 or step S119, the document transmission unit 190 may transmit the proposal document (including the modified proposal document) to the sales representative 2 or the customer 3. The document transmission unit 190 may transmit the proposal document to the sales representative 2 or the customer 3 in response to an instruction from the sales representative 2 or the customer 3. The document transmission unit 190 may transmit the proposal document to the user in step S115 or step S119, or may transmit the proposal document to the user after step S119.

The server apparatus 10 according to the present embodiment acquires format information of a document, generates text data to be included in the document based on a speech recognition result of a dialog conducted by a plurality of users, and generates document data indicating the document based on the text data and the format information. In one aspect, according to the present embodiment, since a document based on the content of the dialog can be automatically created in a predetermined format, the burden on the user to create the document can be reduced.

The server apparatus 10 may generate text data based on information relating to an object mentioned in a dialog. In one aspect, according to the present embodiment, document data relating to an object mentioned in a dialog can be generated.

The server apparatus 10 may search for information relating to an object based on a topic of a dialog extracted from a speech recognition result. In one aspect, according to the present embodiment, document data relating to an object associated with the topic of the dialog can be generated.

The plurality of users may include a customer and a sales representative. The document may include a proposal document, minutes, a report, or a contract. In one aspect, according to the present embodiment, various documents can be created based on a dialog between the customer and the sales representative.

The topic may include the needs of the customer. The object may include a product handled by the sales representative. In one aspect, according to the present embodiment, a document relating to a product associated with the needs of the customer can be created.

The server apparatus 10 may present to the user a list of products mentioned in the dialog. The server apparatus 10 may generate document data indicating a proposal document relating to a product designated by the user. In one aspect, according to the present embodiment, a proposal document relating to a product desired by the user can be created.

The server apparatus 10 may transmit the document data to at least one of the plurality of users. In one aspect, according to the present embodiment, the user can easily obtain the created document.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality. There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a compact disc (CD)-ROM or DVD, and/or the memory of an FPGA or ASIC.

The group of apparatuses described in the examples merely illustrates one of a plurality of computing environments for implementing the embodiments disclosed in the present specification. The server apparatus 10 may include a plurality of computing devices, such as a server cluster. The plurality of computing devices are configured to communicate with each other via any example of communication link, including a network or shared memory, and to execute the processing disclosed in the present specification.

Each functional configuration of the server apparatus 10 may be consolidated into a single server apparatus, or may be divided among a plurality of apparatuses. Furthermore, at least a part of the functional configurations of the server apparatus 10 may be disposed in the terminal apparatus 50.

Aspects of the present disclosure are, e.g., as follows.

### Aspect 1

An information processing apparatus includes a format acquisition unit that acquires format information of a document,
a speech recognition unit that acquires a speech recognition result of a dialog performed by a plurality of users,
a text generation unit that generates text data to be included in the document based on the speech recognition result, and
a document generation unit that generates document data indicating the document based on the text data and the format information.

### Aspect 2

In the information processing apparatus according to Aspect 1, the text generation unit generates the text data based on information related to a target object mentioned in the dialog, and
the document generation unit generates the document data related to the target object.

### Aspect 3

The information processing apparatus according to Aspect 2 further includes a search unit that searches for information related to the target object based on the topic of the dialog extracted from the speech recognition result.

### Aspect 4

In the information processing apparatus according to Aspect 3, the plurality of users include a customer and a sales representative, and
the document includes proposal material, a meeting minute, a report, or a contract.

### Aspect 5

In the information processing apparatus according to Aspect 4, the topic includes a need of the customer, and
the target object includes a product handled by the sales representative.

### Aspect 6

The information processing apparatus according to Aspect 5 further includes a presentation unit that presents a list of the products mentioned in the dialog to the user, and
the document generation unit generates the document data indicating the proposal material related to the product designated by the user.

### Aspect 7

The information processing apparatus according to any one of Aspects 1 to 6 further includes a document transmission unit that transmits the document data to at least one of the plurality of users.

### Aspect 8

An information processing system includes a terminal apparatus and an information processing apparatus communicable with the terminal apparatus through a network.

The terminal apparatus includes
a format input unit that transmits format information of a document to the information processing apparatus and
a speech input unit that transmits, to the information processing apparatus, speech data indicating a speech utterance of a dialog performed by a plurality of users.

The information processing apparatus includes
a format acquisition unit that receives the format information from the terminal apparatus,
a speech recognition unit that acquires a speech recognition result of the dialog,
a text generation unit that generates text data to be included in the document based on the speech recognition result, and
a document generation unit that generates document data indicating the document based on the text data and the format information.

### Aspect 9

An information processing method performed by one or more computers includes acquiring format information of a document,
acquiring a speech recognition result of a dialog performed by a plurality of users,
generating text data to be included in the document based on the speech recognition result, and
generating document data indicating the document based on the text data and the format information.

### Aspect 10

A program causes one or more computers to perform an information processing method including acquiring format information of a document,
acquiring a speech recognition result of a dialog performed by a plurality of users,
generating text data to be included in the document based on the speech recognition result, and
generating document data indicating the document based on the text data and the format information.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

In the related art, there remains room for reducing the effort required to prepare documents. For example, when proposal materials could not be prepared immediately in the context of a business negotiation or meeting, it was necessary to take the materials back, reconsider the composition, prepare the proposal materials anew, and then conduct another visit or meeting. When the preparation of proposal materials requires significant effort or time, there is a risk that, before a subsequent visit can be made, a competitor may seize the contract opportunity, resulting in loss of the deal.

According to the present invention, the effort required to prepare a document can be reduced.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a compact disc (CD)-ROM or DVD, and/or the memory of an FPGA or ASIC.

1. An information processing apparatus comprising circuitry configured to:
acquire format information of a document;
acquire a speech recognition result of a dialog performed by a plurality of users;
generate text data to be included in the document based on the speech recognition result; and
generate document data indicating the document based on the text data and the format information.

2. The information processing apparatus according to claim 1, wherein the circuitry is configured to:
generate the text data based on information related to a target object mentioned in the dialog; and
generate the document data related to the target object.

3. The information processing apparatus according to claim 2,
wherein the circuitry is further configured to search for information related to the target object based on a topic of the dialog extracted from the speech recognition result.

4. The information processing apparatus according to claim 3,
wherein the plurality of users include a customer and a sales representative,
wherein the document includes at least one of proposal material, a meeting minute, a report, or a contract.

5. The information processing apparatus according to claim 4,
wherein the topic includes a need of the customer,
wherein the target object includes a product handled by the sales representative.

6. The information processing apparatus according to claim 5, wherein the circuitry is further configured to:
present a list of the products mentioned in the dialog to the user; and
generate the document data indicating the proposal material related to the product designated by the user.

7. The information processing apparatus according to claim 1,
wherein the circuitry is further configured to transmit the document data to at least one of the plurality of users.

8. An information processing method comprising:
acquiring format information of a document;
acquiring a speech recognition result of a dialog performed by a plurality of users;
generating text data to be included in the document based on the speech recognition result; and
generating document data indicating the document based on the text data and the format information.

9. A non-transitory recording medium storing a plurality of instructions which, when executed by one or more processors, causes the one or more processors to perform an information processing method comprising:
acquiring format information of a document;
acquiring a speech recognition result of a dialog performed by a plurality of users;
generating text data to be included in the document based on the speech recognition result; and
generating document data indicating the document based on the text data and the format information.
